(19) United States
(12) Patent Application Publication
(10) Pub. No.: US 2014/0262267 A1
(43) Pub. Date: Sep. 18, 2014

(54) WELL SEALING TECHNOLOGY

(71) Applicants: Vincent Eugene Fustos, Hermitage, PA (US); Ronald J. Janoski, Chagrin Falls, OH (US)

(72) Inventors: Vincent Eugene Fustos, Hermitage, PA (US); Ronald J. Janoski, Chagrin Falls, OH (US)

(21) Appl. No.: 13/829,696

(22) Filed: Mar. 14, 2013

(51) Int. Cl. C09K 8/00; E21B 33/13

(52) U.S. Cl. CPC C09K 8/00; E21B 33/13
USPC 166/292; 521/154

(57) ABSTRACT

A method for sealing a wellbore around a pipe placed within it is disclosed. The method includes providing to a wellbore site a pre-mixed pre-polymer sealant solution and storing the sealant until use. The sealant material may be injected into wellbore in the space exterior to the pipe so that the sealant material contacts at least some portion of the pipe exterior surface and the wellbore interior surface. Upon injection, the sealant material may begin to cure from contact with moisture in the ground, the curing causing the sealant material to release a gas and form a sealing foam into the extra-pipe space. The sealing foam may then be permitted to cure to form a flexible and stable seal.

### BACKGROUND

Fracking, or hydraulic fracturing, is a technique that may be used to increase the productivity of underground wells. Such wells may be used to obtain oil, gas, water, or other minerals found in the underlying geological strata. In some cases, the minerals may flow easily from underground. For example trapped natural gas may flow up a pipe in a wellbore due to reduced pressure. In other cases, the subterranean minerals may need to be pumped out (such as oil) or flushed out using a solvent (such as salt from underground salt formations).

In some instances, the minerals may be found in fractures, pockets, or other inclusions in the geological strata. These minerals may not readily flow or be extracted into a wellbore, and standard pumping or flushing techniques may leave behind a significant amount of material. Under these conditions, fracking may be used to mechanically disrupt the geological strata, causing the inclusions to enlarge and/or merge into larger structures that may allow easier access to the minerals. Fracking may be performed by injecting some material (a “fracking fluid”) at high pressure down the wellbore. At sufficient pressure, the underlying strata may fracture allowing easier and more complete extraction of the minerals within them. The fracking fluid may also include small structures (“propants”) used to keep the enlarged fractures open after the pressure has been released.

It may be appreciated that the fracking procedure may require a tight seal between the pipe through which the fracking fluid is delivered and the walls of the wellbore. If vent space exists between the irregular wellbore wall and the smooth pipe exterior surface, then pressure may be lost to the atmosphere as the fracking fluid is injected. Such pressure loss may result in the fracking process becoming inefficient. Therefore, it is reasonable to apply a seal between the pipe and the wellbore to maintain the pressure as the underlying strata is fractured by the fracking fluid.

The invention described in this document is not limited to the particular systems, methodologies or protocols described, as these may vary. The terminology used herein is for the purpose of describing particular embodiments only, and is not intended to limit the scope of the present disclosure.

It must be noted that as used herein, the singular forms “a,” “an,” and “the” include plural reference unless the context clearly dictates otherwise. Unless defined otherwise, all technical and scientific terms used herein have the same meanings as commonly understood by one of ordinary skill in the art. As used herein, the term “comprising” means “including, but not limited to.”

In an embodiment, a method of sealing a wellbore around a pipe inserted into the wellbore may include providing a pre-mixed pre-polymer sealant solution, storing the pre-mixed pre-polymer sealant solution at a wellbore site, providing a wellbore within a portion of geological strata at the wellbore site, the wellbore having an inserted pipe thereby creating an extra-pipe space, bounded by at least a portion of a pipe outer surface and at least a portion of a wellbore inner surface, injecting into the extra-pipe space at least a first portion of the pre-mixed pre-polymer sealant solution, allowing the at least first injected portion of the pre-mixed pre-polymer sealant solution within the extra-pipe space to contact moisture within the extra-pipe space, thereby causing the at least first injected portion of the pre-polymer sealant solution to emit a gas and to form a sealing foam filling at least a portion of the extra-pipe space, and allowing the sealing foam to cure, thereby forming a foam seal within the portion of the extra-pipe space.

### BRIEF DESCRIPTION OF THE DRAWINGS

FIG. 1 illustrates examples of wellbores within geological strata in accordance with the present disclosure.

FIG. 2 illustrates an example of strata surrounding a wellbore pipe in accordance with the present disclosure.

FIGS. 3A, B illustrate an example of an effect of sudden pressure applied to a concrete seal around a wellbore pipe in accordance with the present disclosure.

FIGS. 3C-E illustrate an example of an effect of sudden pressure applied to a polymer foam seal around a wellbore pipe in accordance with the present disclosure.

FIG. 4 is a flow chart of an illustrative method of sealing a wellbore around an inserted pipe in accordance with the present disclosure.

### DETAILED DESCRIPTION

As disclosed above, the fracking process includes drilling a wellbore, inserting a wellbore pipe into the wellbore and injecting a fracking fluid down the pipe into the underlying strata. The pressure generated by the fluid injection may lead to small fissures in the strata enlarging, thereby permitting improved fluid flow from the strata through the wellbore pipe. It may be appreciated that significant force must be applied to the fracking fluid in order to enlarge the small fissures within the strata. Additionally, a well bore may include horizontal components along with the vertical component to insert the well vertically into the strata. Such horizontal components may be useful to allow the pipe to have access to a seam particularly rich in the material to be pumped out of the well.

FIG. 1 illustrates some of the elements associated with a fracking wellbore. Two wellbores, 110a and 110b, are illustrated in FIG. 1. Both penetrate the ground which may be composed of a number of overlapping and partially overlapping strata 130. Wellbore 110a is merely a vertical shaft. Wellbore 110b includes a horizontal bore 140 that may follow a seam of geologically important material, such as oil or gas. it may be appreciated that normal well boring equipment is typically designed for vertical drilling. Horizontal bores 140, however, may be accomplished by placing a number of shaped charges aimed at some horizontal angle from the main well bore. Such charges may be repetitively “shot” into the strata, resulting in small successive explosions capable of carving out a non-vertical bore. It may be appreciated that such explosions, confined to the vertical and horizontal borehole may generate significant pressure and shockwave forces. Such forces may result in transient pressures of about 37.5 Mpsi (258 GPa) to about 112.5 Mpsi (775 GPa), with transient shock waves traveling at a velocity of about 75 Kft/sec (22.8 Km/sec) to about 225 Kft/sec (68.5 Km/sec). It may be appreciated that containment of such large transient forces may be necessary to protect the well equipment and personnel, as well as assure that the explosive force is efficiently used to create the horizontal bore. It may be appreciated that the use of some sealant between the wellbore and the pipe 120 may help contain such forces.

FIG. 2 illustrates a close-up view of the interface between the wellbore and pipe, labeled as 120 in FIG. 1. The wellbore pipe 210 is depicted having a pipe exterior surface 215 that is adjacent to the non-smooth drilled surface 235 of the geological strata 230. It may be appreciated that during the drilling process, the drilled surface 235 from the geological strata 230 is most likely irregular. As a result, a smooth pipe surface 215 most likely will not normally form a tight seal against the drilled surface 235, and thus an explosive force within the wellbore may have a place to vent, decreasing the efficiency of the explosion below. It thus becomes reasonable to provide a seal between the exterior surface of the pipe 215 and the drilled surface 235 of the strata.

FIGS. 3A-E illustrate type of seals that may be considered to assist in containing the explosive force of both the shaped charges (for horizontal bored creation) as well as the force of the fracking fluid injected down the wellbore.

FIGS. 3A and B illustrate the effect of using a concrete or cement seal. FIG. 3A illustrates a cured concrete or cement seal 350a molded between a well pipe 310 and the drilled surface 335 of the strata 330. While concrete is inexpensive, and easily manipulated, concrete, once set, may be brittle. It may be understood that the crush, compressive, and tensile strengths of concrete can be several orders of magnitude less than the force generated by subsurface mining explosions. Thus, as illustrated in FIG. 3B, such concrete seals 350b may be prone to failure during fracking and drilling operations.

It may be appreciated, therefore, that a seal made of a material capable of withstanding such shock forces may be desirable in the applications associated with sealing a wellbore pipe within the wellbore. Such a material should be able to undergo a reversible plastic deformation when exposed to such forces. Such a material may perform substantially as illustrated in FIGS. 3C-E.

FIG. 3C, similar to FIG. 3A, illustrates a borehole pipe 310 inserted into a borehole having an irregular strata surface 335. While the seal 350a in FIG. 3A may be composed of concrete or cement, the seal 350c may be composed of a deformable material, such as a polyurethane foam. As illustrated in FIG. 3D, a shockwave 370 generated by either the horizontal explosive charge or the pressure of the fracking fluid may travel up the space between the pipe 310 and the surface of the strata 350c resulting in compression of the deformable seal 350d. Such a seal 350d may be compressed without breaking. After the passage of the shock wave (FIG. 3E), the deformable seal may return to its pre-stressed shape 350e and continue its function of sealing the pipe 310 against the strata surface 335.

It may be appreciated that, during a fracking procedure, the borehole pipes may be subjected to a variety of stresses. The pressure of the fracking liquid, after injection into the borehole, may be maintained at a steady state hydraulic pressure of about 0 psi (0 MPa) to about 30,000 psi (205 MPa). Under such steady pressure, a polyurethane foam seal may compress and becomes equal to cement in density. As a result, the polyurethane foam seal may create the same permeation seal as provided by cement, but with a superior casing pipe-to-seal adhesion.

In addition to the static hydraulic pressure, shockwave vibrations may be produced as a result of the explosive force of the shaped charges used to expand the borehole horizontally. The frequency spectrum of such explosive blasts may be complex and may extend into the terahertz region. The effects of the vibrations may generally be two-fold: shock waves may be directly transmitted through the borehole; and the pipe inserted into the borehole may resonate at specific shock-induced frequencies. Due to the density and material differences between cement and steel pipe, the pipe may resonate at higher frequencies (for example greater than the KHz range) than the concrete. The difference in vibrational modes between the pipe and the concrete seal may shatter the concrete seal with both macro and micro fissures. As a result, the concrete may crack along the interfaces of the cement matrix and the concrete aggregate. In distinction, the polyurethane foam will not crack under vibration since the foam density matrix may allow for movement at the micro-fiber level due to its ability to deform in a plastic manner. As a result, a urethane foam seal may absorb the vibrations and not shatter or break.

In addition to the effects of vibration, the sudden blast pressure may also have a greater destructive impact on concrete than on a polyurethane foam. At sufficiently high impact pressure, for example at around 500 psi (3.4 MGa), the concrete structure may begin to break down. At higher impact pressures, the destructive effect on the concrete may increase. Unlike concrete, a polyurethane foam may not break apart as pressure increases, but may merely compact.

The differences in physical properties between a compressible and plastically deformable material, such as a polyurethane foam, and a more rigid material, such as concrete, may be appreciated based on the information in Table 1.

TABLE 1

| Physical Measurement | Polyurethane Foam | Concrete |
|---|---|---|
| Tensile Strength | ~21 | 2-5 |
| (MPa) | | |
| Young's Modulus | ~1 | 14-41 |
| (GPa) | | |
| Shear Strength | ~5 | ~0.34 |
| (MPa) | | |
| Compressibility | ~0.4 | ~50 |
| (MPa) | | |

It may be appreciated that the values in Table 1 may be considered for illustrative purposes only, as the properties of a particular type of urethane foam may depend on its composition and manner of preparation. Similarly, the properties of any particular type of concrete may depend on its composition. Nevertheless, it may be understood, based on the values illustrated in Table 1, that a polyurethane foam has a greater general tensile strength than concrete. Additionally, the polyurethane foam may be more deformable as illustrated by the lower relative values of the Young's modulus and shear strength of the foam versus the concrete. The polyurethane foam may also be observed to be more compressible than the concrete, as evidenced by the much lower compressibility value of the foam compared to that of the concrete. Such properties taken together may indicate that a polyurethane foam may be able to withstand sudden shock waves and high compressive forces by plastic deformation. Concrete, in comparison, may not deform in response to such forces, and may simply shatter along the boundaries of the cement matrix and the aggregate.

Such a compressible seal may best be fabricated in situ to assure its surfaces conform to both the pipe and the strata surface. One type of compressible sealing material may include a polyurethane foam. Polyurethane foams may be used to form seals between static pipes or beams and the ground into which they have been inserted. Typically, such polyurethane foams may be prepared by mixing together one or more diisocyanates and one or more polyols with appropriate catalysts and other agents at the construction site. This process may be cumbersome since separate chemicals must be supplied to the site along with a mixing and injecting device. Because water may be required to foam the polyurethane, water may also have to be supplied along with the monomeric reagents and mixed with them as well. It may be appreciated that a large scale sealing operation that may occur at a fracking site may make such multi-stage preparation and injection of the sealant precursors unwieldy. Therefore, a simpler method of merely injecting a pre-formed precursor of a polyurethane foam may be advantageous in this application.

One non-limiting example of such a method is presented in the flowchart in FIG. 4. A premixed polymer sealant solution may be supplied 410 to the site where it may be used, such as a fracking well. The solution may be stored 420 at the site until it is needed. It may be appreciated that providing 410 a pre-mixed solution and storing 420 it on-site may have the advantage of having the sealant material available when needed, and not requiring complex components and mixing equipment to remain dormant until used. A wellbore having a pipe inserted within it may be provided 430 when the drilling process has reached a state at which the sealant material may be required. The sealant material may be injected between the pipe and the wellbore side wall in one or more operations. At least one part of the pre-mixed sealant solution may be injected 440 between the pipe exterior surface and the wellbore interior surface. The first amount of sealant may contact water in the wellbore surface and a urethane foam may be created 450. In some non-limiting examples, the pre-polymer sealant solution may emit a gas and foam for about 15 minutes to about 2 hours after injection. The foam may be allowed to cure 460 thereby forming the seal. In some non-limiting examples, about one hour to about three hours may be required for the sealing foam to cure. It is understood that additional seals may be formed after the first amount of sealing mixture has been allowed to cure by repeating the steps of injecting 440 more pre-mixed solution, allowing 450 the injected solution to contact subsurface water, and allowing the foamed polyurethane to cure 460 thereby forming additional sealing components.

The pre-mixed polyurethane sealant may be fabricated by placing an amount of a poly-isocyanate material into a moisture-free tank, layering a dry gas over the poly-isocyanate material, and adding to the tank an amount of a polyol material and a pre-polymer catalyst. The solution in the tank may be mixed to form the pre-mixed pre-polymer sealant solution. In one non-limiting example, the sealant solution may be maintained at a temperature less than or equal to about 70 degrees C. (160 degrees F.) during the mixing process. In another non-limiting example, the sealant solution may be maintained at a temperature less than or equal to about 50 degrees C. (122 degrees F.).

The poly-isocyanate material may include one or more of the following: 2,4-toluene diisocyanate, 2,6-toluene diisocyanate, 1,3-phenelyne diisocyanate, 1,4-phenelyne diisocyanate, polymeric diphenylmethane diisocyanate, naphthalene-1,5-diisocyanate, triphenyl-methane triisocyanate, polyphony-polyethylene-polyisocyanate, norbornane isocyanate, isophorone diiosocyanate, hydrogenated methylene diphenyl diisocyanate, hexamethylene diisocyanate, toluene diisocyanate, methylene bis-(4-cyclohexylisocyanate), aliphatic modified methylene diphenyl diisocyanate, urea modified methylene diphenyl diisocyanate, polymeric methylene bis phenyldiisocyanite, 4,4 ethylene bis phenyldiisocyanite, methylene diphenyl diisocyanate, 2,4 methylene diphenyl diisocyanate, 2,6 methylene diphenyl diisocyanate, and combinations and variants thereof.

The polyol material may include one or more of the following: polyether polyols having at least 2 hydroxyl moieties, poly-oxyalkylene polyols, castor oil-based polyols, soy oil-based polyols, oleic oil-based polyols, sunflower oil-based polyols, polyoxypropylene oxide-based polyols, polyoxyethylene-based polyols, glycerol-based polyols, sugar-based polyols, starch-based polyols, recycled polyethylene terephthalate-based polyols, caprolactones, tetraphydrofuran-based polyols, polyester polyols, pentaerythritol, sorbitol, sucrose, polycarbonate, amine terminated polyols, and maleinized polyols.

A stoichiometric ratio of isocyanate groups in the polyisocyanate material to hydroxyl groups in the polyol material may be about 2.1:1 to about 15:1.

The pre-polymer catalyst may be composed of one or more of the following: di-butyl-tin-dilaurate, tin octoate, tin acetate, dioctyl-tin carboxylate, an organo-bismuth compound, and an organo-zinc compound.

In addition to the reagents disclosed above, an amount of a foaming and curing catalyst, such as a hindered amine, may additionally be added to the mixture. Non-limiting examples of such a foaming and curing catalyst may include one or more of the following: dimorpholinodiethyl ether, pentamethyldiethylenetriamine, and dimethylbenzylamine.

In addition to the reagents disclosed above, an amount of an adhesion promoter may be added to the mixture. Non-limiting examples of such an adhesion promoter comprises one or more of the following: an organofunctional silane and an organofunctional titanate.

In addition to the reagents disclosed above, an amount of a desiccant may be added to the mixture. Non-limiting examples of such a desiccant may include one or more of the following: calcium oxide, magnesium oxide, maleic anhydride, oxazolidiene, and p-toluenesulfonyl isocynate.

In addition to the reagents disclosed above, an amount of a fibrous reinforcing material may be added to the mixture. Non-limiting examples of such a fibrous reinforcing material may include one or more of the following: poly-paraphenylene terephthalamide, poly-metaphenylene terephthalamide, polyethylene, nylon, ceramic fibers, and polymeric fibers.

As disclosed above, the pre-mixed sealant solution may foam and cure within the space between the pipe and the borehole based solely on water already present within the subsurface strata. In an alternative method of producing the seal in situ, at least some portion of the pipe outer surface and/or at least a portion of the wellbore inner surface may be coated or sprayed with water and/or an accelerator. Alternatively, water and/or an accelerator may be mixed with the pre-mixed pre-polymer sealant solution during the injection down the borehole. If multiple injections of the pre-mixed pre-polymer sealant solution are required additional amounts of water and/or an accelerator may be injected into the extra-pipe space after the first foam seal has cured.

### EXAMPLES

### Example 1

### A First Formulation of a Pre-Mixed Pre-Polymer Sealant Solution

A first formulation of a pre-mixed pre-polymer sealant solution may contain the following components in about the following amounts by percent weight:

| | Amount |
|---|---|
| Component | (Percent by Weight) |
| Polymeric Methylene Diphenyl Diisocyanate | 48% |
| (2.8 Functionality) | |
| Polyoxypropylene Polyol | 48% |
| (220-028) | |
| Dibutyltin Dilaurate | 0.25% |
| Dimorpholino Diethyl Ether | 0.25% |
| Glycidoxy Functional Silanol | 2% |
| Drying Agent | 1.5% |

The first formulation may have several useful properties including a stable shelf-life, delayed foam formation when pumped down a borehole, and a rapid curing time once the foam is formed. The formulation may be readily injected into a borehole for ease of application.

### Example 2

### A Second Formulation of a Pre-Mixed Pre-Polymer Sealant Solution

A second formulation of a pre-mixed pre-polymer sealant solution may contain the following components in about the following amounts by percent weight:

| | Amount |
|---|---|
| Component | (Percent by Weight) |
| Polymeric Methylene Diphenyl Diisocyanate | 32.47% |
| (2.3 Functionality) | |
| Polyoxypropylene Polyol | 65% |
| (220-028) | |
| Dibutyltin Diacetate | 0.17% |
| Formic Acid Blocked Amine Catalyst | 0.22% |
| Pentamethylenetriamine | 0.57% |
| Amino Silane | 1% |
| p-Toluenesulfonyl Isocyanate | 0.57% |

This second formulation may use components and catalysts particularly suited for warmer temperatures.

### Example 2

### A Third Formulation of a Pre-Mixed Pre-Polymer Sealant Solution

A third formulation of a pre-mixed pre-polymer sealant solution may contain the following components in about the following amounts by percent weight:

| | Amount |
|---|---|
| Component | (Percent by Weight) |
| Methylene Diphenyl Diisocyanate | 25% |
| Polyether Polyol | 72% |
| Tin Laurate | 0.25% |
| Dimorpholino Diethyl Ether | 0.25% |
| Glycidoxy Functional Silanol | 2% |
| p-Toluenesulfonyl Isocyanate | 0.5% |

This third formulation includes pure methylene diphenyl diisocyanate, which has a low viscosity even at lower temperatures. Thus, this formulation may be particularly suitable for colder climates.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated in this disclosure, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can, of course, vary. It is also to be understood that the terminology used in this disclosure is for the purpose of describing particular embodiments only, and is not intended to be limiting.

With respect to the use of substantially any plural and/or singular terms in this disclosure, those having skill in the art can translate from the plural to the singular and/or from the singular to the plural as is appropriate to the context and/or application. The various singular/plural permutations may be expressly set forth in this disclosure for sake of clarity.

It will be understood by those within the art that, in general, terms used in this disclosure, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or, “B” or “A and B.”

As will be understood by one skilled in the art, for any and all purposes, such as in terms of providing a written description, all ranges disclosed in this disclosure also encompass any and all possible subranges and combinations of subranges thereof. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member.

From the foregoing, it will be appreciated that various embodiments of the present disclosure have been described for purposes of illustration, and that various modifications may be made without departing from the scope and spirit of the present disclosure. Accordingly, the various embodiments disclosed are not intended to be limiting, with the true scope and spirit being indicated by the following claims.

What is claimed is:

1. A method of sealing a wellbore around a pipe inserted therein comprising:
providing a pre-mixed pre-polymer sealant solution;
storing the pre-mixed pre-polymer sealant solution at a wellbore site;
providing a wellbore within a portion of geological strata at the wellbore site, the wellbore having a pipe inserted therein thereby creating an extra-pipe space, wherein the extra-pipe space is bounded by at least a portion of a pipe outer surface and at least a portion of a wellbore inner surface;
injecting into the extra-pipe space at least a first portion of the pre-mixed pre-polymer sealant solution;
allowing the at least first injected portion of the pre-mixed pre-polymer sealant solution within the extra-pipe space to contact moisture within the extra-pipe space, thereby causing the at least first injected portion of the pre-polymer sealant solution to emit a gas and to form a sealing foam filling at least a portion of the extra-pipe space; and
allowing the sealing foam to cure, thereby forming a foam seal within the at least a portion of the extra-pipe space.

2. The method of claim 1, wherein providing a pre-mixed pre-polymer sealant solution comprises:
placing a first portion of a poly-isocyanate material into a moisture-free tank;
layering an amount of a dry gas over the first portion of the poly-isocyanate material;
adding a second portion of a polyol material to the first portion of the poly-isocyanate material in the tank;
adding a third portion of a pre-polymer catalyst to the tank; and
mixing the first portion, the second portion, and the third portion in the tank, thereby forming the pre-mixed pre-polymer sealant solution.

3. The method of claim 2, wherein mixing the first portion, the second portion, and the third portion in the tank further comprises cooling the pre-mixed pre-polymer sealant solution to a temperature less than or equal to about 70 degrees C. (160 degrees F.).

4. The method of claim 2, wherein mixing the first portion, the second portion, and the third portion in the tank further comprises cooling the pre-mixed pre-polymer sealant solution to a temperature less than or equal to about 50 degrees C. (122 degrees F.).

5. The method of claim 2, wherein the poly-isocyanate material comprises one or more of the following: 2,4-toluene diisocyanate, 2,6-toluene diisocyanate, 1,3-phenelyne diisocyanate, 1,4-phenelyne diisocyanate, polymeric diphenylmethane diisocyanate, naphthalene-1,5-diisocyanate, triphenyl-methane triisocyanate, polyphony-polyethylene-polyisocyanate, norbornane isocyanate, isophorone diiosocyanate, hydrogenated methylene diphenyl diisocyanate, hexamethylene diisocyanate, toluene diisocyanate, methylene bis-(4-cyclohexylisocyanate), aliphatic modified methylene diphenyl diisocyanate, urea modified methylene diphenyl diisocyanate, polymeric methylene bis phenyldiisocyanite, 4,4 ethylene bis phenyldiisocyanite, methylene diphenyl diisocyanate, 2,4 methylene diphenyl diisocyanate, 2,6 methylene diphenyl diisocyanate, and combinations and variants thereof.

6. The method of claim 2, wherein the polyol material comprises one or more of the following: polyether polyols having at least 2 hydroxyl moieties, poly-oxyalkylene polyols, castor oil-based polyols, soy oil-based polyols, oleic oil-based polyols, sunflower oil-based polyols, polyoxypropylene oxide-based polyols, polyoxyethylene-based polyols, glycerol-based polyols, sugar-based polyols, starch-based polyols, recycled polyethylene terephthalate-based polyols, caprolactones, tetraphydrofuran-based polyols, polyester polyols, pentaerythritol, sorbitol, sucrose, polycarbonate, amine terminated polyols, and maleinized polyols.

7. The method of claim 2, wherein the pre-polymer catalyst comprises one or more of the following: di-butyl-tin-dilaurate, tin octoate, tin acetate, dioctyl-tin carboxylate, an organo-bismuth compound, and an organo-zinc compound.

8. The method of claim 2, further comprising adding to the tank an amount of a foaming and curing catalyst.

9. The method of claim 8, wherein the foaming and curing catalyst comprises one or more of the following: dimorpholinodiethyl ether, pentamethyldiethylenetriamine, and dimethylbenzylamine.

10. The method of claim 2, further comprising adding to the tank an amount of an adhesion promoter.

11. The method of claim 10, wherein the adhesion promoter comprises one or more of the following: an organofunctional silane and an organofunctional titanate.

12. The method of claim 2, further comprising adding to the tank an amount of a desiccant.

13. The method of claim 12, wherein the desiccant comprises one or more of the following: calcium oxide, magnesium oxide, maleic anhydride, oxazolidiene, and p-toluenesulfonyl isocynate.

14. The method of claim 2, wherein a stoichiometric ratio of isocyanate groups in the first portion of the polyisocyanate material to hydroxyl groups in the second portion of the polyol material is about 2.1:1 to about 15:1.

15. The method of claim 2, further comprising adding to the tank an amount of a fibrous reinforcing material.

16. The method of claim 15, wherein the fibrous reinforcing material comprises one or more of the following: poly-paraphenylene terephthalamide, poly-metaphenylene terephthalamide, polyethylene, nylon, ceramic fibers, and polymeric fibers.

17. The method of claim 1, wherein providing a wellbore within a portion of geological strata comprises contacting at least the portion of the pipe outer surface, at least the portion of the wellbore inner surface, or at least the portion of the pipe outer surface and at least the portion of the wellbore inner surface with one or more of the following: water and an accelerator.

18. The method of claim 17, wherein contacting comprises one or more of the following: coating and spraying,

19. The method of claim 1, wherein injecting into the extra-pipe space at least a first portion of the pre-mixed pre-polymer sealant solution further comprises injecting one or more of the following: water and an accelerator.

20. The method of claim 1, wherein a first amount of time between injecting at least the first portion of the pre-mixed pre-polymer sealant solution into the extra-pipe space and at least the first injected portion of the pre-polymer sealant solution emitting a gas and forming a sealing foam is about 15 minutes to about 2 hours.

21. The method of claim 1, wherein a second amount of time between injecting at least the first portion of the pre-mixed pre-polymer sealant solution into the extra-pipe space and the sealing foam curing to form a foam seal is about one hour to about three hours.

22. The method of claim 21, further comprising injecting at least a second portion of the pre-mixed pre-polymer sealant solution into the extra-pipe space after the second amount of time.

23. The method of claim 21, further comprising injecting at least a second portion of the pre-mixed pre-polymer sealant solution and an amount of water and an accelerator into the extra-pipe space after the second amount of time.

24. A sealing material around a wellbore pipe, the material comprising a cured foam polymer adapted to compressibly deform upon receiving a shockwave pressure greater than about 500 psi (3.4 MPa).
